(19) United States
(12) Patent Application Publication
(10) Pub. No.: US 2017/0316402 A1
(43) Pub. Date: Nov. 2, 2017

(54) SYSTEM FOR MAPPING A TEMPORARY ACCOUNT IDENTIFIER TO A COMPROMISED ACCOUNT IDENTIFIER

(71) Applicant: MasterCard International Incorporated, Purchase, NY (US)

(72) Inventor: Raghuraman Anantharaman, Wildwood, MO (US)

(21) Appl. No.: 15/141,588

(22) Filed: Apr. 28, 2016

(51) Int. Cl. G06Q 20/34; G06Q 20/40

(52) U.S. Cl. CPC G06Q 20/342; G06Q 20/409

(57) ABSTRACT

A computer-implemented method for linking a prepaid account to a compromised account for processing payment transactions using an account mapping computing device is provided. The method includes receiving a mapping request for linking the prepaid account to the compromised account. The method further includes storing a mapping entry linking the prepaid account identifier to the compromised account identifier and receiving an authorization request message representing a transaction initiated by a cardholder using the prepaid account. The method includes detecting that the received prepaid account identifier has a corresponding mapping entry stored and updating the received authorization request message by replacing the prepaid account identifier with the linked compromised account identifier. The method includes transmitting the updated authorization request message that includes the compromised account identifier and storing transactional information associated with the processed transaction associated the compromised account.

### BACKGROUND

The present application relates generally to mapping a temporary account identifier to a compromised account identifier, and more particularly, to a network-based system for mapping a temporary account identifier to a compromised account identifier and associating all transactions performed with the temporary account identifier thereafter with the compromised account identifier.

Losing one or more payment cards (i.e., credit or debit cards) or a smartphone that virtually stores one or more payment cards through theft or loss can be a stressful and difficult situation, especially while one is traveling. Being without a credit card may severely hinder a traveler's ability to book a hotel or a flight unless the traveler, in the off chance, possesses large sums of cash. Generally, when a payment card is compromised, a traveler must contact his or her issuer bank to give notification that traveler's payment card is lost or stolen. The issuer bank usually deactivates the payment card immediately to prevent any potential fraudulent transaction associated with the payment card account and mails out a new payment card to the traveler to allow the traveler to begin conducting transactions again with his or her payment account.

However, if the traveler happens to lose his or her payment card late on a Friday night or over the weekend, the issuer bank associated with the traveler's payment card is likely unavailable because the timing is outside business hours or the lack of reachable representatives. Even in the case where a cardholder is able to reach and to notify the issuer bank about the stolen or lost payment card, the issuer bank may still require one to three days to mail a new payment card and potentially longer for the cardholder to actually receive his or her new payment card. This situation may be more tenuous for a traveler abroad dealing with language barriers, different currency, etc. Moreover, the mail system in many parts of the world is slow and unreliable and may require many days or even weeks to mail a new payment card to a potentially stranded traveler. In this case, the traveler realistically has no choice but to wire money via a money transfer vendor. Generally wiring money, especially while located abroad, is time consuming, stressful, and sometimes includes high fees.

Furthermore, every day that a cardholder does not possess his or her payment card, especially for high value monthly transaction cardholders (e.g., affluent cardholders, business travelers, etc.), the issuer bank may be forgoing revenue from lost transactions during the interim wait time between the deactivation of the compromised payment card and the delivery and activation of the new payment card. With ever-increasing occurrences of global payment card fraud, issuer banks struggle with these lost transaction fee revenues because cardholders are unable to conduct transactions for this interim time period.

Accordingly, a system is needed that is configured to map a temporary account identifier, upon receiving a mapping request, to a compromised account identifier and that thereafter may associate transactions, despite being performed with the temporary account identifier, with the compromised account identifier.

### BRIEF DESCRIPTION OF THE DISCLOSURE

In one aspect, an account mapping computing device used for linking a prepaid account to a compromised account for processing payment transactions is provided. The account mapping device includes a processor coupled to a memory and to a data source. The processor configured to receive, from an issuer of the compromised account, a mapping request for linking the prepaid account to the compromised account. The mapping request includes both a prepaid account identifier and a compromised account identifier. The processor is further configured to store, in the data source, a mapping entry linking the prepaid account identifier to the compromised account identifier in response to receiving the mapping request. The processor is further configured to receive an authorization request message representing a transaction initiated by a cardholder using the prepaid account. The authorization request message includes the prepaid account identifier. The processor is configured to detect that the received prepaid account identifier has a corresponding mapping entry stored within the data source and update the received authorization request message by replacing the prepaid account identifier with the linked compromised account identifier. Moreover, the processor is configured to transmit, to the issuer of the compromised account, the updated authorization request message that includes the compromised account identifier and store transactional information associated with the processed transaction in the data record associated the compromised account.

In another aspect, a computer-implemented method for linking a prepaid account to a compromised account for processing payment transactions using an account mapping computing device is provided. The account mapping computing device includes a processor coupled to a memory and to a data source. The method includes receiving, from an issuer of the compromised account, a mapping request for linking the prepaid account to the compromised account. The mapping request includes both a prepaid account identifier and a compromised account identifier. The method further includes storing, in the data source, a mapping entry linking the prepaid account identifier to the compromised account identifier in response to receiving the mapping request and receiving an authorization request message representing a transaction initiated by a cardholder using the prepaid account. The authorization request message includes the prepaid account identifier. The method also includes detecting that the received prepaid account identifier has a corresponding mapping entry stored within the data source and updating the received authorization request message by replacing the prepaid account identifier with the linked compromised account identifier. Furthermore, the method includes transmitting, to the issuer of the compromised account, the updated authorization request message that includes the compromised account identifier and storing transactional information associated with the processed transaction in the data record associated the compromised account.

In a further aspect, a computer-readable storage media having computer-executable instructions embodied thereon is provided. When executed by at least one processor associated with an account mapping computing device, the computer-executable instructions cause the processor to receive, from an issuer of the compromised account, a mapping request for linking the prepaid account to the compromised account. The mapping request includes both a prepaid account identifier and a compromised account identifier. The computer-executable instructions further cause the processor to store, in the data source, a mapping entry linking the prepaid account identifier to the compromised account identifier in response to receiving the mapping request and to receive an authorization request message representing a transaction initiated by a cardholder using the prepaid account. The authorization request message includes the prepaid account identifier. The computer-executable instructions also cause the processor to detect that the received prepaid account identifier has a corresponding mapping entry stored within the data source and to update the received authorization request message by replacing the prepaid account identifier with the linked compromised account identifier. Furthermore, the computer-executable instructions cause the processor to transmit, to the issuer of the compromised account, the updated authorization request message that includes the compromised account identifier and to store transactional information associated with the processed transaction in the data record associated the compromised account.

### BRIEF DESCRIPTION OF THE DRAWINGS

FIG. 1 is a schematic diagram illustrating an example multi-party payment card processing system for processing payment card transactions and for mapping a temporary account identifier to a compromised account identifier in accordance with an example embodiment of the present disclosure.

FIG. 2 is a simplified block diagram of an example account mapping system including a plurality of computing devices as shown in FIG. 1.

FIG. 3 is an expanded block diagram of an example embodiment of a server architecture of the account mapping system shown in FIG. 2 including the plurality of computing devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a flowchart of an example process that may be performed by the account mapping system of FIGS. 2 and 3 for linking a prepaid account to a compromised account for processing payment transactions.

### DETAILED DESCRIPTION OF THE DISCLOSURE

Account holders and cardholders, especially while traveling, rely heavily on using payment cards (e.g., credit cards, debit cards, a mobile device storing credit card/debit information, etc.) to purchase items, such as flights, hotels, meals, rental cars, etc., that are necessary while traveling. However, in the unfortunate instance that a traveler's payment card is lost, misplaced, stolen, or otherwise compromised, the traveler may be unable to book a hotel or a flight to continue his or her trip (or return home) unless the traveler is carrying sufficient cash, additional uncompromised payment cards, etc.

According to various aspects described herein, an account mapping system allows an account holder to use, for an interim time period, a temporary payment account (e.g., prepaid payment card) in lieu of a lost, stolen, or otherwise compromised permanent payment account. For example, an account holder may desire to temporarily use a newly purchased prepaid payment card in lieu of a lost, stolen, misplaced, or otherwise compromised permanent payment card. After obtaining a prepaid card, the card holder notifies his or her issuer bank (i.e., the issuer bank that issued the permanent payment card to the account holder) that the account holder's payment card has been compromised. Additionally, when notifying the issuer bank, the account holder relays information about a newly purchased prepaid payment card, such as an account identifier, prepaid amount stored with the prepaid account, etc. to the issuer bank. Alternatively, the issuer bank may recommend to the traveler to purchase a pre-paid payment card from a local retail store at the time the traveler provides notification to the issuer bank of the traveler's compromised payment card.

In turn, the issuer bank may send a mapping request, such as electronically transmitting a file, a data record, or any other suitable electronic manner to convey a mapping request, to an account mapping computing device for mapping the prepaid payment account to the permanent payment card. The mapping request may include data associated with the prepaid payment account and the permanent payment account (e.g., a related prepaid payment account identifier, a related permanent payment account identifier), expiration dates for one or both of the prepaid payment account and the permanent payment account, or any other related data desired for mapping accounts. Moreover, the mapping request may additionally include multiple prepaid payment account identifiers and corresponding multiple permanent payments account identifiers such that the account mapping computer device may perform batch processing for multiple mappings for an entire group of account holders. Continuing this example, the account mapping system may store the account mapping for the received prepaid account and the permanent account as an account mapping data record in an account mapping database and may notify the issuer bank of the approved mapping.

Thus, all transactions conducted with the prepaid payment card thereafter will be associated with the compromised permanent payment card. Specifically, in response to receiving an authorization request that includes the prepaid payment account identifier from the issuer bank, the account mapping computing device may detect the prepaid payment account identifier by performing a search query in the account mapping database with the prepaid payment account identifier and/or corresponding expiration date, for example. If a mapping data record is returned from the search query, the account mapping computing device may amend the authorization request by replacing the prepaid payment account identifier with the permanent payment account identifier (from the returned mapping data record) for a particular data field of the authorization request. Additionally, the prepaid payment account identifier may be stored in another data field of the authorization request such that the issuer bank is made aware of both the prepaid payment account identifier and the permanent payment account identifier during the authorization of the transaction. Moreover, the account mapping computing device may store a successful mapping indicator (or unsuccessful mapping indicator in some cases) in yet another data field of the authorization field.

In any event, after a successful mapping and processing the transaction related to the prepaid payment account, the account mapping device may temporarily store these interim transactions in a transaction database (or, alternatively, in the account mapping database) until the issuer bank provides an entirely new permanent payment card to the cardholder. When the issuer bank notifies the account mapping device that a new permanent payment card has been issued to (and activated by) the account holder, the account mapping device suspends the mapping from the temporary payment account to the permanent payment account. Furthermore, the payment account mapping device may perform clearing and settlement of the transactions processed with temporary prepaid payment card after the mapping is disabled.

According to various examples described herein, an account mapping system is configured to communicate with a payment processor that is in communication with a payment processing network, to receive mapping requests from issuer banks. The account mapping device is configured to receive, from an issuer, a mapping request to temporarily map a prepaid payment account to a permanent payment account associated with an account holder. The mapping request may include both a prepaid payment account identifier and a permanent payment account identifier. In response to receiving the mapping request, the processor may store, in a data source, a mapping entry linking the prepaid payment account identifier to permanent payment account identifier. Both prepaid payment account identifiers and permanent payment account identifiers may include any type of schema, such as an alpha-numerical identifier, tokenized identifier, etc. One type of identifier, for example, includes a primary account number (PAN) that may be used to identify a specific payment account.

Thus, when an account mapping computing device receives a mapping request from an issuer bank, the mapping request may include a PAN for a temporary payment account that is to be mapped to a different PAN associated with a compromised permanent payment account. For example, a PAN, such as “ABC123”, may be assigned to a prepaid payment account and a different PAN, such as “XYZ456”, may be assigned to a compromised permanent payment account. Continuing this example, upon receiving a mapping request from an issuer, an account mapping device may store a mapping entry that links (i.e., maps, associates, etc.) the prepaid payment account PAN “ABC123” to the permanent payment account PAN “XYZ456”. Thus, when a payment processor receives a transaction authorization request for the prepaid payment account PAN “ABC123”, the payment processor communicates with the account mapping device to determine whether the PAN “ABC123” is associated with a mapping entry. With the determination that a mapping entry is associated with the PAN “ABC123”, the account mapping device retrieves and inserts the mapped PAN “XYZ456” in place of the prepaid payment account PAN “ABC123” into the authorization request message. The account mapping device may transmit the updated authorization request to the payment processor for forwarding to the issuer to complete the transaction.

Additionally, the account mapping device may store a time stamp that indicates when the mapping request was received. When a request is received to suspend or to cease mapping the prepaid payment account to the permanent payment account, the account mapping device may disable the mapping entry in the data record associated with the prepaid payment account and may store another time stamp associated with the receipt of the request to disable the account mapping. After storing all the transactional information that occurred during the mapping period in a temporary account, the account mapping device may perform settlement and clearing activities between the issuer of the prepaid payment account and the issuer of the permanent payment account.

The methods and systems described herein may be implemented using computer programming or engineering techniques including computer software, firmware, hardware or any combination or subset thereof, wherein the technical effects may be achieved by performing one of the following steps: (a) receiving, from an issuer of the compromised account, a mapping request for linking the prepaid account to the compromised account, the mapping request including both a prepaid account identifier and a compromised account identifier; (b) in response to receiving the mapping request, storing, in the data source, a mapping entry linking the prepaid account identifier to the compromised account identifier; (c) receiving an authorization request message representing a transaction initiated by a cardholder using the prepaid account, the authorization request message including the prepaid account identifier; (d) detecting that the received prepaid account identifier has a corresponding mapping entry stored within the data source; (e) updating the received authorization request message by replacing the prepaid account identifier with the linked compromised account identifier; (f) transmit, to the issuer of the compromised account, the updated authorization request message that includes the compromised account identifier; and (g) store transactional information associated with the processed transaction in the data record associated the compromised account.

By performing these steps, the systems are configured to solve a problem in computer networking (e.g., payment network) and in allowing a cardholder to use a temporary payment account (e.g., a prepaid payment account) in lieu of the cardholder's compromised permanent payment account. As described herein, the implementation for a mapping a temporary payment account to a compromised permanent payment account for a limited time period is performed closely with the payment network, payment processor, and the account mapping computing device. As such, allowing a cardholder to use a temporary payment account in lieu of the cardholder's compromised permanent payment account by mapping the temporary account to the compromised account for processing transactions cannot be performed without the technical solution herein described.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

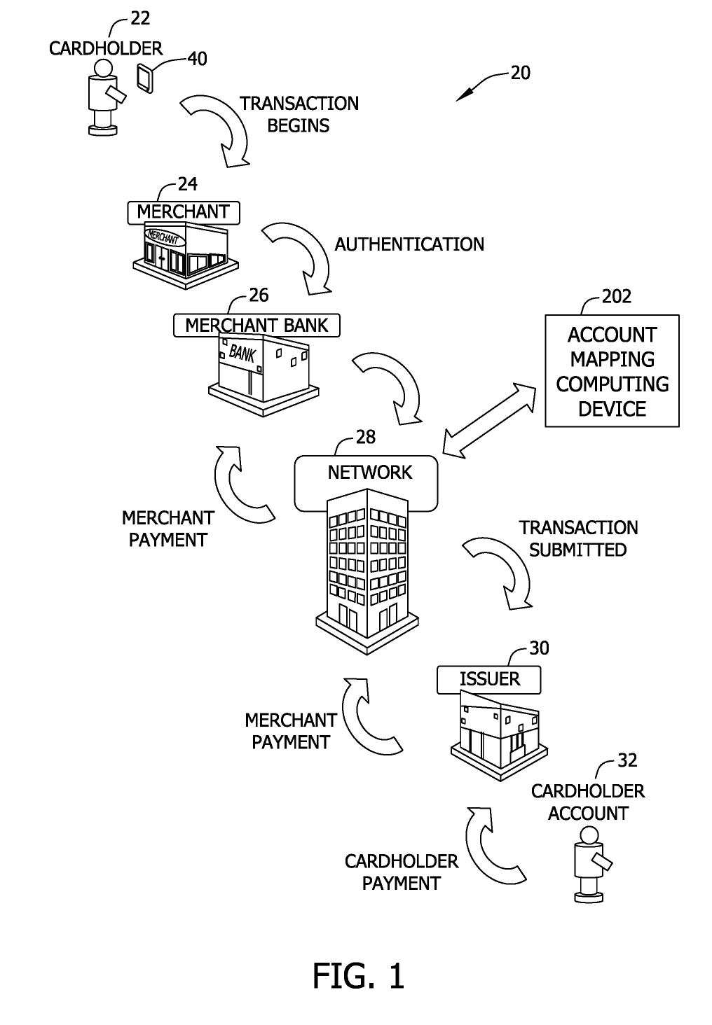

FIG. 1 is a schematic diagram illustrating an example multi-party payment processing system 20 for processing payment-by-card transactions that is in communication with an account mapping computing device 202. Payment processing system 20 includes payment network 28 (also referred to as an “interchange” or “interchange network”). Payment network 28 could be the MasterCard® payment card network. MasterCard® payment card network is a proprietary communications standard promulgated by MasterCard International Incorporated® for the exchange of financial transaction data between financial institutions that are associated with MasterCard International Incorporated®. (MasterCard is a registered trademark of MasterCard International Incorporated located in Purchase, New York).

In payment processing system 20, a financial institution such as an issuer 30 (i.e., an issuer bank) issues a payment account card, such as a credit card account or a debit card account, to a cardholder 22 (i.e., an account holder), who uses the payment account card to tender payment for a purchase from a merchant 24. To accept payment with the payment account card, merchant 24 must normally establish an account with a financial institution that is part of the financial payment system. This financial institution is usually called the “merchant bank” or the “acquiring bank” or “acquirer bank” or simply “acquirer”. When a cardholder 22 tenders payment for a purchase with a payment account card (also known as a financial transaction card), merchant 24 requests authorization from acquirer 26 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 26. Alternatively, acquirer 26 may authorize a third party to perform transaction processing on its behalf In this case, the point-of-interaction terminal will be configured to communicate with the third party. Such a third party is usually called a “merchant processor” or an “acquiring processor.”

Using payment network 28, the computers of acquirer 26 or the merchant processor will communicate with the computers of issuer 30, to determine whether the cardholder's account 32 is in good standing and whether the purchase is covered by the cardholder's available credit line or account balance. Based on these determinations, the request for authorization will be declined or accepted. If the request is accepted, an authorization code is issued to merchant 24.

When a request for authorization is accepted, the available credit line or available balance of cardholder's account 32 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 24 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account 32 is decreased. Normally, a charge is posted immediately to cardholder's account 32. The bankcard association then transmits the approval to the acquiring processor for distribution of goods/services, or information or cash in the case of an ATM.

After a transaction is captured, the transaction is settled between merchant 24, acquirer 26, and issuer 30. Settlement refers to the transfer of financial data or funds between the merchant's account, acquirer 26, and issuer 30 related to the transaction. Usually, transactions are captured and accumulated into a “batch,” which is settled as a group.

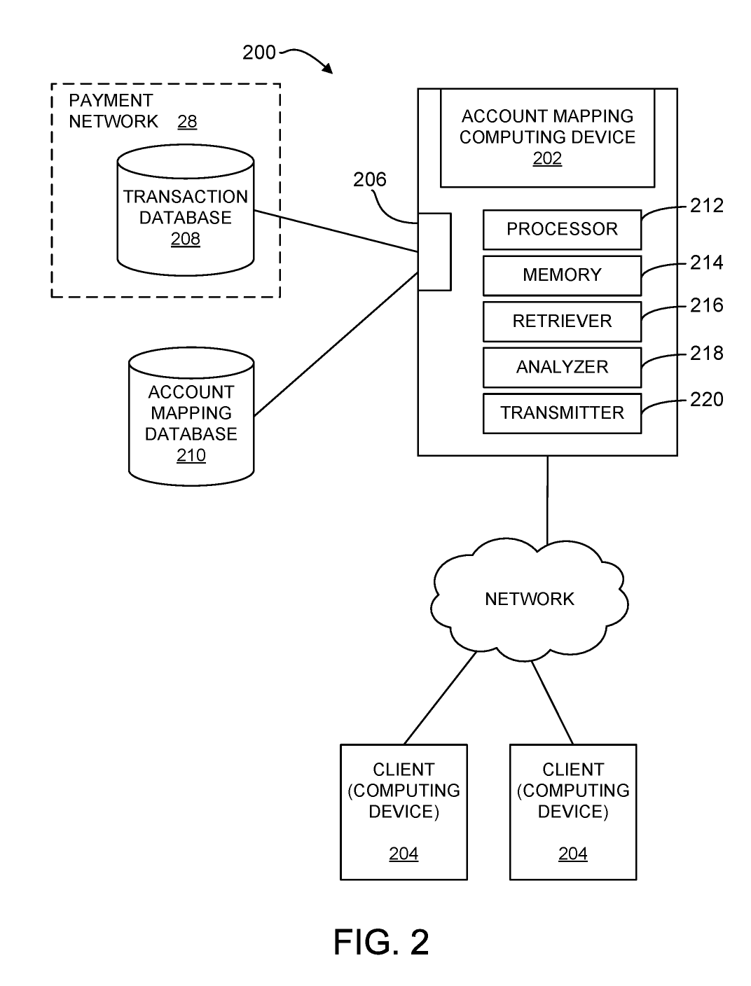

FIG. 2 is a simplified block diagram of an example account mapping system 200 as shown in FIG. 2 in accordance with one embodiment of the present disclosure. In the example embodiment, account mapping system 200 includes account mapping computing device 202 (e.g., a server) and a plurality of client subsystems, also referred to as client devices 204 or client computing devices, connected to account mapping computing device 202. In one embodiment, client devices 204 are computers including a web browser, such that mapping computing device 202 is accessible to client devices 204 using the Internet or any other suitable network. Client systems 204 are interconnected to the Internet through many interfaces including a network, such as a local area network (LAN) and/or a wide area network (WAN), dial-in connections, cable modems, wireless-connections, and special high-speed ISDN lines. Client devices 204 may be any device capable of interconnecting to the Internet including a web-based phone, personal digital assistant (PDA), or other web-connectable equipment. A database server 206 is communicatively coupled to a mapping computing database 210 and to a transaction database 208 containing transaction data as described above in greater detail. In one embodiment, transaction database 208 is disposed within account mapping computing device 202 and may be accessed by potential users at one of client devices 204 by logging onto account mapping computing device 202 through one of client devices 204. In any alternative embodiment, transaction database 208 is stored remotely from account mapping computing device 202 and may be non-centralized. Account mapping computing device 202 may include a processor 212, a memory 214, a retriever 216, an analyzer 218, and a transmitter 220. The account mapping computing device 202 may include additional components not shown, or less than the amount of components shown.

The retriever 216, disposed within the account mapping computing device 202, may obtain transaction data or account mapping data from either or both of transaction database 208 or account mapping database 210. For example, the retriever 216 may receive transaction data for a specific temporary payment account that is mapped to a compromised payment account during a particular time period. The analyzer 218 may process and analyze the retrieved transaction data and the account mapping data. The transmitter 220 may provide any account mapping data or related transaction data to client device 204. For example, an issuer 30 may utilize client device 204 to transmit account mapping requests to account mapping device 202 for a compromised cardholder account 32 or to request transaction data for one or more stored transactions performed during the temporary mapping period. Alternatively, an issuer 30 may transmit an account mapping request to the account mapping computing device 202 via the payment network 28.

The account mapping database 210 may include account mapping entry data that links a temporary prepaid payment account identifier with a compromised permanent payment account identifier. These account mapping entries may additionally include one or more time stamps that each denote when a particular account mapping entry was created, disabled, or even modified in some cases. The account mapping entry may include token mapping data to link or to associate the temporary prepaid account and the permanent account when both accounts are issued by the same issuer bank 30. On the other hand, for the scenarios when the temporary prepaid account and the permanent account are issued by two different, respective issuer banks, the account mapping entry may include issuer data that denotes the issuer bank of the temporary prepaid account. This issuer data associated with the temporary prepaid account may assist in clearing and settlement activities between the two issuer banks during the temporary account mapping time period or after the account mapping time period has concluded.

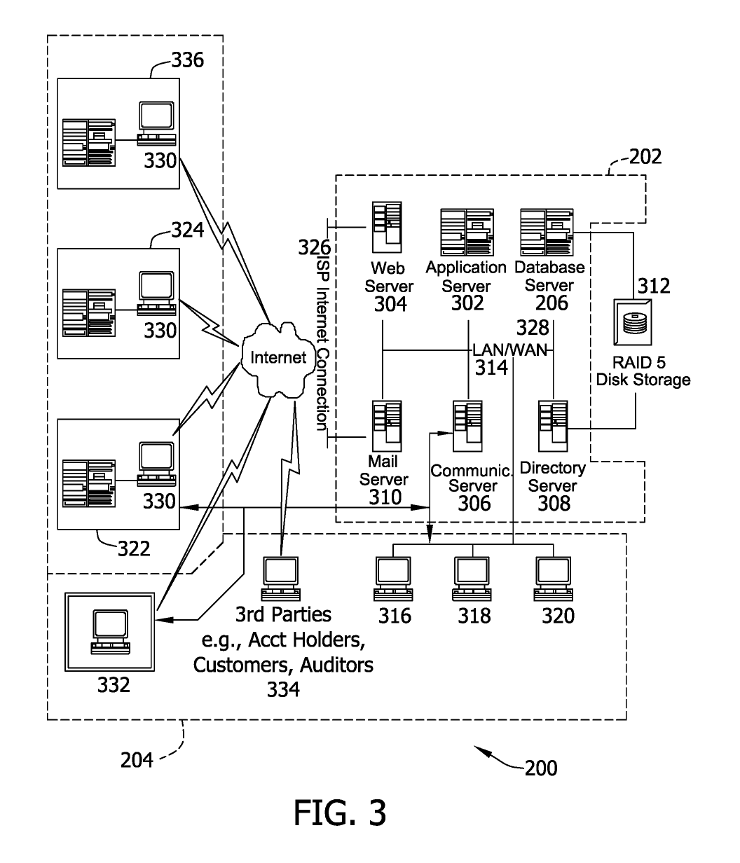

FIG. 3 is an expanded block diagram of an example embodiment of a server architecture of account mapping system 200 in accordance with one embodiment of the present disclosure. Account mapping system 200 includes account mapping computing device 202 and client systems 204. Account mapping computing device 202 further includes database server 206, an application server 302, a web server 304, a communication server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet. For example, one of the workstations 320 may include the payment processor 336 and respective payment processing database.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Account mapping computing device 202 is configured to be communicatively coupled to various entities, including acquirers 322 and issuers 324, and to third parties, e.g., auditors, 334 using an Internet connection 326. Account mapping computing device 202 is also communicatively coupled with a payment processor 336. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 200. At least one of the client systems includes a manager workstation 332 located at a remote location. Workstations 330 and 332 include personal computers having a web browser. Also, workstations 330 and 332 are configured to communicate with account mapping computing device 202. Furthermore, communication server 306 communicates with remotely located client systems, including a client system 332, using a telephone link. Communication server 306 is configured to communicate with other client systems 316, 318, and 320 as well.

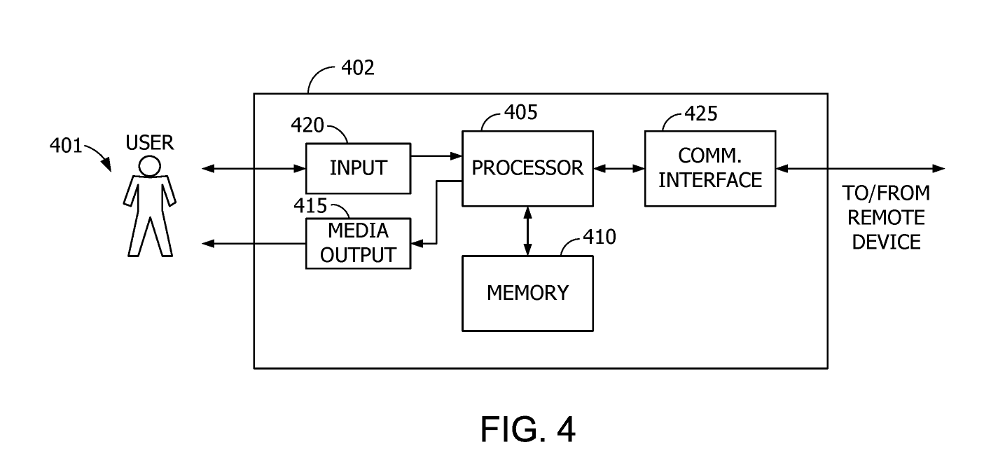

FIG. 4 illustrates an example configuration of a requester computing device 402 operated by a requestor 401 (i.e., user, issuer bank, etc.) whom may desire to transmit a mapping request to the account mapping computing device 202. Requester computing device 402 may include, but is not limited to, client systems (“client computing devices”) 204, 316, 318, and 320, workstation 330, and manager workstation 332 (shown in FIG. 3).

Requester computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Requester computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, requester computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Requester computing device 402 may also include a communication interface 425, which is communicatively couplable to a remote device such as account mapping computing device 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to user 401 via media output component 415 and, optionally, receiving and processing input from input device 420. A user interface may include, among other possibilities, a web browser and client application. Web browsers enable cardholders, such as user 401, to display and interact with media and other information typically embedded on a web page or a website from account mapping computing device 202 or a web server associated with a merchant. A client application allows user 401 to interact with a server application from account mapping computing device 202 or a web server associated with a merchant.

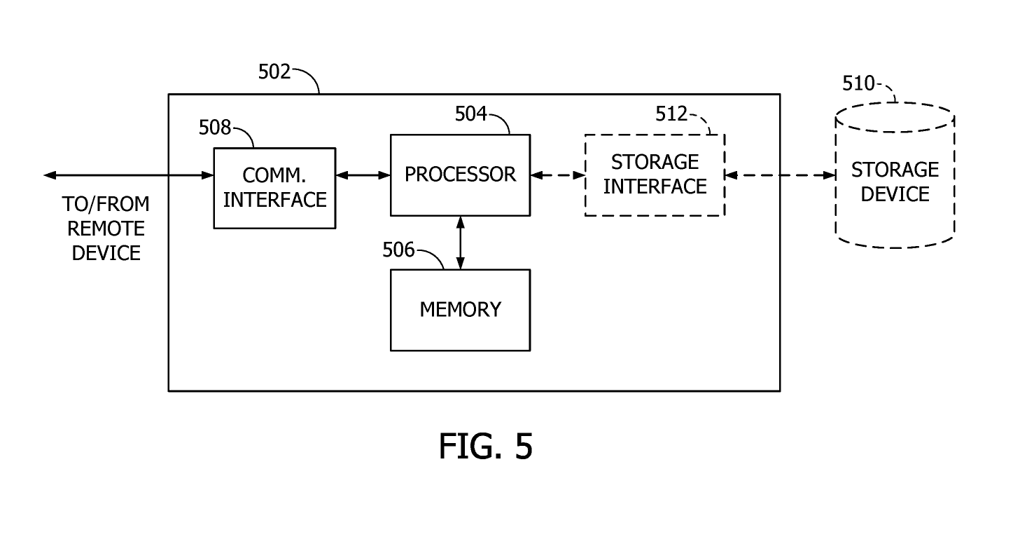

FIG. 5 illustrates an example configuration of an account mapping computing device 502 such as account mapping computing device 202 (shown in FIGS. 2 and 3). Account mapping computing device 502 may include, but is not limited to, database server 206 (shown in FIG. 2), application server 302, web server 304, communication server 306, directory server 308, and mail server 310 (shown in FIG. 3).

Account mapping computing device 502 includes a processor 504 for executing instructions that may be stored in a memory area 506, for example. Processor 504 may include one or more processing units (e.g., in a multi-core configuration) and is operatively coupled to a communication interface 508 such that account mapping computing device 502 is capable of communicating with a remote device such as requester computing device 402 or another account mapping computing device 502. For example, communication interface 508 may receive requests from client devices 204 via the Internet, as illustrated in FIGS. 2 and 3.

Processor 504 may also be operatively coupled to a storage device 510. Storage device 510 is any computer-operated hardware suitable for storing and/or retrieving data. In some embodiments, storage device 510 is integrated in account mapping computing device 502. For example, account mapping computing device 502 may include one or more hard disk drives as storage device 510. In other embodiments, storage device 510 is external to server computing device 502 and may be accessed by a plurality of account mapping computing devices 502. For example, storage device 510 may include multiple storage units such as hard disks or solid state disks in a redundant array of inexpensive disks (RAID) configuration. Storage device 510 may include a storage area network (SAN) and/or a network attached storage (NAS) system. Account mapping data stored in account mapping database 210 (shown in FIG. 2) may alternatively and/or additionally be stored in the storage device 510.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory areas 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

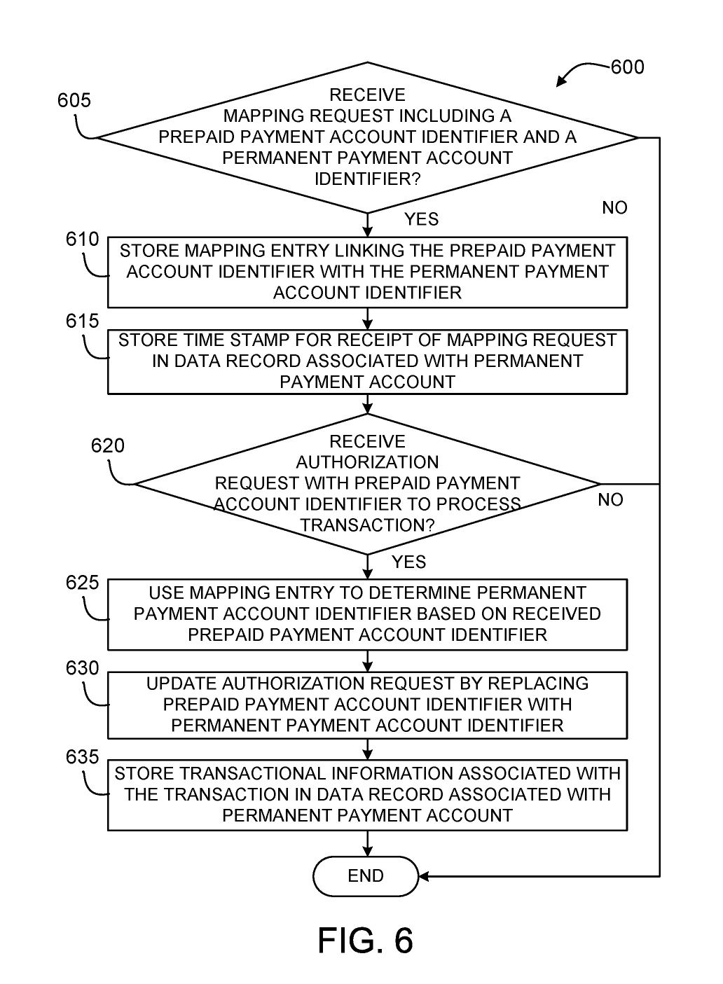

FIG. 6 is a flowchart of an example process 600 for allowing a cardholder to perform transaction using a temporary prepaid payment account in lieu of a compromised permanent payment account. Process 600 may be implemented or performed by account mapping system 200. Initially, account mapping computing device 202 receives 605, from an issuer bank, a mapping request to map a temporary account identifier (e.g., a PAN for a prepaid payment card) to a permanent account identifier (e.g., a PAN for a compromised permanent credit or debit payment card). The mapping request may not only include both the temporary account identifier and the permanent account identifier but may also include additional data related to account mapping such as a temporary account issuer bank indicator that denotes an issuer bank associated with the received temporary account identifier. The additional data related to account mapping may also include a value indicator that represents a value amount associated with or stored on the temporary payment account, a predetermined mapping time period indicator that indicates a time period for the account mapping to be enabled (and disabled after the lapse of the indicated time period), and/or any other suitable data related to account mapping.

In any event, upon receiving the mapping request, account mapping device 202 may generate and may store 610 a mapping entry (e.g., database record entry, data record, etc.) in account mapping database 210. The mapping entry includes the mapping (i.e., linking, association, etc.) relationship between both the temporary account identifier and the permanent account identifier received in the mapping request. Any additional data or information (e.g., the temporary account issuer bank, the value indicator, the predetermined mapping time period indicator, etc.) may also be stored with or in the mapping entry in the account mapping database 210 by the account mapping computing device 202. Furthermore, account mapping computing device 202 may additionally store 615 a first time stamp (e.g., a mapping time stamp) denoting the time of receipt of the mapping request received from the issuer bank in the account mapping database 210 and associate the time stamp with the mapping entry. The time stamp may be used by the account mapping computing device 202 to determine whether the mapping for a particular temporary account identifier is enabled. Likewise, if a request to disable the account mapping between the temporary account and the permanent account is received, a second time stamp (e.g., a disable mapping time stamp) may be stored in the data record or mapping entry. This disable mapping time stamp may denote the time that the disable mapping request was received from the issuer bank. Account mapping computing device 202 may utilized the disable mapping time stamp to determine that the mapping between the temporary account and permanent account is no longer active.

Nonetheless, after storing the mapping entry associated with the temporary account and permanent account, the account mapping computing device 202 may receive 620 an authorization request to process a transaction associated with an account identifier. In response to receiving the authorization request, account mapping computing device 202 identifies whether the received account identifier in the authorization request is a temporary account identifier that was previously stored in a mapping entry in the account mapping database 210. Account mapping computing device 202 may identify a temporary prepaid account identifier based on a portion of the identifier or unique sequence within the received account identifier. Otherwise, account mapping database 210 may be queried for each account identifier associated with each received authorization request by account mapping computing device 202.

Upon the determination that the received account identifier is a temporary prepaid account identifier, account mapping computing device 202 may query account mapping database 210 using the prepaid account identifier to determine a related mapping entry and determine 625 the permanent account identifier mapped to the temporary prepaid account identifier. Account mapping computing device 202 may update or amend the authorization request by replacing the received temporary prepaid account identifier with the permanent account identifier stored in the retrieved mapping entry. The amended authorization request may be forwarded, similar to an unamended authorization request, to the issuer bank associated with the permanent account for further approval or processing. Account mapping computing device 202 may store 635 the transactional information of the processed transaction in the mapping entry stored in the account mapping database 210, in a new data record stored in the account mapping database 210, in the transaction database 208, or any other suitable storage device. After the mapping between the temporary prepaid account and the permanent account is disabled, account mapping computing device 202 may transmit all temporarily stored transaction (i.e., all transactions processed during the mapping time period) to one or more of the issuer banks for clearing and settling. If one issuer bank issued both the permanent account and the prepaid temporary account, then account mapping computing device 202 may transmit all the transactions during mapping period to that one issuer bank to clear and settle the transactions. However, if the permanent account and the temporary prepaid account were issued by two different issuers, account mapping computing device 202 may assist in clearing and settlement between the two issuer banks.

For example, a cardholder, who recently lost his or her permanent payment card, purchases a prepaid payment card from Issuer Bank A for $25 and requests that Issuer Bank B (that issued the cardholder's permanent payment account) map the prepaid payment card to the now compromised permanent payment card. Issuer Bank B in turn sends to account mapping computing device 202 a mapping request that includes the prepaid account identifier, the permanent account identifier, a value indicator indicating $25, and issuer bank indicator indicating Issuer Bank A. Continuing this example, account mapping computing device 202 generates and stores in the account mapping database 210 a mapping entry that indicates that the received prepaid account identifier is mapped to the received permanent account identifier and stores a time stamp of the time of receipt of the mapping request. Account mapping computing device 202 also may store the value indicator of $25 in the mapping entry with the issuer bank indicator denoting Issuer Bank A issued the prepaid account.

After the mapping entry is generated and store and when authorization requests are received, the account mapping computing device 202 may deplete the $25 of value stored in the prepaid account before sending the authorization requests onto the Issuer Bank B for approval. In other embodiments, the prepaid $25 may not be used for transaction processing because the prepaid payment account is mapped with the permanent payment account, and the account mapping computing device 202 may later settle and clear the $25 between the two issuer banks. After the mapping is requested to be disabled, the account mapping computing device 202 may perform clearing and settlement between Issuer Bank A and Issuer Bank B for the transactions processed during the mapping period. Alternatively, the two issuer banks may independent settle and clear the transactions between the prepaid payment account and the permanent payment account, including the prepaid $25 by the account holder.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 504, including RAM memory, ROM memory, EPROM memory, EEPROM memory, and non-volatile RAM (NVRAIVI) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An account mapping computing device for linking a prepaid account to a compromised account for processing payment transactions, the account mapping device comprising a processor coupled to a memory and to a data source, the processor configured to:
receive, from an issuer of the compromised account, a mapping request for linking the prepaid account to the compromised account, the mapping request including both a prepaid account identifier and a compromised account identifier;
in response to receiving the mapping request, store, in the data source, a mapping entry linking the prepaid account identifier to the compromised account identifier;
receive an authorization request message representing a transaction initiated by a cardholder using the prepaid account, the authorization request message including the prepaid account identifier;
detect that the received prepaid account identifier has a corresponding mapping entry stored within the data source;
update the received authorization request message by replacing the prepaid account identifier with the linked compromised account identifier;
transmit, to the issuer of the compromised account, the updated authorization request message that includes the compromised account identifier; and
store transactional information associated with the processed transaction in the data record associated the compromised account.

2. The account mapping computing device of claim 1, the processor further configured to:
store, in the data source, a first time stamp in the data record associated with the compromised account, the first time stamp indicating a first date and a first time associated with the receipt of the mapping request.

3. The account mapping computing device of claim 2, the processor further configured to:
receive, from the issuer, a request to cease mapping the prepaid account to the compromised account; and
disable the mapping entry in the data record associated with the prepaid account; and
store a second time stamp in a data record associated with the compromised account, the second time stamp indicating a second date and a second time associated with the receipt of the request to cease mapping.

4. The account mapping computing device of claim 2, the processor further configured to:
in response to a lapse of a predetermined period of time from the first time stamp, disable the mapping entry in the data record associated with the prepaid account; and
store a second time stamp in a data record associated with the compromised account, the second time stamp indicating a second date and a second time associated with the receipt of the request to cease mapping.

5. The account mapping computing device of claim 1, the processor further configured to determine a value amount associated with the prepaid account.

6. The account mapping device of claim 5, the processor further configured to:
determine, using the compromised account issuer identifier and the prepaid account issuer identifier, whether the issuer of prepaid account is different from the issuer of the compromised account;
in response to the determination that the issuer of the prepaid account is different from the issuer of the compromised account, process the clearing and settlement transactions between the issuer of the prepaid account and the issuer of the compromised account for the stored transactional information.

7. The account mapping computing device of claim 1, wherein the mapping request includes one or more other compromised account identifiers associated with the account holder, and wherein in response to receiving the mapping request, the processor is further configured to:
store, in the data source, one or more time stamp identifiers in one or more corresponding data records associated with the one or more other compromised accounts associated with the account holder.

8. A computer-implemented method for linking a prepaid account to a compromised account for processing payment transactions using an account mapping computing device that includes a processor coupled to a memory and to a data source, said method comprising:
receiving, from an issuer of the compromised account, a mapping request for linking the prepaid account to the compromised account, the mapping request including both a prepaid account identifier and a compromised account identifier;
in response to receiving the mapping request, storing, in the data source, a mapping entry linking the prepaid account identifier to the compromised account identifier;
receiving an authorization request message representing a transaction initiated by a cardholder using the prepaid account, the authorization request message including the prepaid account identifier;
detecting that the received prepaid account identifier has a corresponding mapping entry stored within the data source;
updating the received authorization request message by replacing the prepaid account identifier with the linked compromised account identifier;
transmitting, to the issuer of the compromised account, the updated authorization request message that includes the compromised account identifier; and
storing transactional information associated with the processed transaction in the data record associated the compromised account.

9. The computer-implemented method of claim 8, further comprising:
storing, in the data source, a first time stamp in the data record associated with the compromised account, the first time stamp indicating a first date and a first time associated with the receipt of the mapping request.

10. The computer-implemented method of claim 9, further comprising:
receiving, from the issuer, a request to cease mapping the prepaid account to the compromised account; and
disabling the mapping entry in the data record associated with the prepaid account; and
storing a second time stamp in a data record associated with the compromised account, the second time stamp indicating a second date and a second time associated with the receipt of the request to cease mapping.

11. The computer-implemented method of claim 9, further comprising:
in response to a lapse of a predetermined period of time from the first time stamp, disabling the mapping entry in the data record associated with the prepaid account; and
storing a second time stamp in a data record associated with the compromised account, the second time stamp indicating a second date and a second time associated with the receipt of the request to cease mapping.

12. The computer-implemented method of claim 8, further comprising:
determining a value amount associated with the prepaid account.

13. The computer-implemented method of claim 12, further comprising:
determining, using the compromised account issuer identifier and the prepaid account issuer identifier, whether the issuer of prepaid account is different from the issuer of the compromised account;
in response to the determination that the issuer of the prepaid account is different from the issuer of the compromised account, processing the clearing and settlement transactions between the issuer of the prepaid account and the issuer of the compromised account for the stored transactional information.

14. The computer-implemented method of claim 8, wherein the mapping request includes one or more other compromised account identifiers associated with the account holder, and further comprising:
in response to receiving the mapping request, storing, in the data source, one or more time stamp identifiers in one or more corresponding data records associated with the one or more other compromised accounts associated with the account holder.

15. Computer-readable storage media having computer-executable instructions embodied thereon, wherein, when executed by at least one processor associated with an account mapping computing device, the computer-executable instructions cause the processor to:
receive, from an issuer of the compromised account, a mapping request for linking the prepaid account to the compromised account, the mapping request including both a prepaid account identifier and a compromised account identifier;
in response to receiving the mapping request, store, in the data source, a mapping entry linking the prepaid account identifier to the compromised account identifier;
receive an authorization request message representing a transaction initiated by a cardholder using the prepaid account, the authorization request message including the prepaid account identifier;
detect that the received prepaid account identifier has a corresponding mapping entry stored within the data source;
update the received authorization request message by replacing the prepaid account identifier with the linked compromised account identifier;
transmit, to the issuer of the compromised account, the updated authorization request message that includes the compromised account identifier; and
store transactional information associated with the processed transaction in the data record associated the compromised account.

16. The computer-readable storage media in accordance with claim 15, wherein the computer-executable instructions cause the processor to:
store, in the data source, a first time stamp in the data record associated with the compromised account, the first time stamp indicating a first date and a first time associated with the receipt of the mapping request.

17. The computer-readable storage media in accordance with claim 16, wherein the computer-executable instructions cause the processor to:
receive, from the issuer, a request to cease mapping the prepaid account to the compromised account; and
disable the mapping entry in the data record associated with the prepaid account; and
store a second time stamp in a data record associated with the compromised account, the second time stamp indicating a second date and a second time associated with the receipt of the request to cease mapping.

18. The computer-readable storage media in accordance with claim 16, wherein the computer-executable instructions cause the processor to:
in response to a lapse of a predetermined period of time from the first time stamp, disable the mapping entry in the data record associated with the prepaid account; and
store a second time stamp in a data record associated with the compromised account, the second time stamp indicating a second date and a second time associated with the receipt of the request to cease mapping.

19. The computer-readable storage media in accordance with claim 15, wherein the computer-executable instructions cause the processor to determine a value amount associated with the prepaid account.

20. The computer-readable storage media in accordance with claim 19, wherein the computer-executable instructions cause the processor to:
determine, using the compromised account issuer identifier and the prepaid account issuer identifier, whether the issuer of prepaid account is different from the issuer of the compromised account;
in response to the determination that the issuer of the prepaid account is different from the issuer of the compromised account, process the clearing and settlement transactions between the issuer of the prepaid account and the issuer of the compromised account for the stored transactional information.
